(19) United States
(12) Patent Application Publication
(10) Pub. No.: US 2003/0191646 A1
(43) Pub. Date: Oct. 9, 2003

(54) Method of setting voice processing parameters in a communication device

(76) Inventors: Robert F. D'Avello, Lake Zurich, IL (US); Scott B. Davis, Walworth, WI (US); Stephen P. Rittmueller, Royal Oak, MI (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/118,278

(22) Filed: Apr. 8, 2002

(51) Int. Cl. G10L 21/00

(52) U.S. Cl. 704/270

(57) ABSTRACT

A method of automatically setting voice processing parameters in a communication device, such as a wired or wireless communication device, is disclosed. The method comprising steps of detecting the selection of a voice recognition call; setting voice processing parameters of the communication device for a voice recognition call; and enabling voice communication with a voice recognition server using the voice processing parameters. Additional embodiments related to communication between a communication device and a voice recognition server are also disclosed.

### FIELD OF THE INVENTION

The present invention relates to communication devices, and more particularly to a method of setting voice processing parameters in a communication device.

### BACKGROUND OF THE INVENTION

As telecommunication systems continue to expand and add new services, such systems are capable of providing useful information to users of communication devices. However, as the amount of information which is accessible by a user of a communication device has increased, the need for “automated” telecommunication services has also dramatically increased. One way of providing automated telecommunication services is to provide a voice recognition (VR) system to provide information to users of communication devices.

Further, the uses for communication devices, such as wireless communication devices, continues to expand. For example, a recent application of wireless communications can be found in the area of telematics. Telematics is a term generally related to the provisioning of data and/or services to vehicles. While current telematics service providers have call centers employing individuals to receive calls from their subscribers, voice recognition systems could significantly reduce the need to employ people to handle calls to the call center. That is, a server based voice recognition system could be used to receive a call from a telematics subscriber for many applications or services provided by the telematics service provider.

However, the accuracy of a server based voice recognition system is closely coupled to the signal to noise ratio of the incoming signal. Often, a noise suppression algorithm is used in a communication device to improve the signal to noise ratio. The performance of the voice recognition system is closely coupled to the performance of the noise suppression algorithm, including the improvement in the signal to noise ratio as well as the voice distortion inherent in most noise suppression algorithms. Most server based voice recognition systems request that the signal be provided to them as clean as possible, i.e., with no noise suppression algorithm running. However, if the background noise level becomes too great, it may be necessary to provide some noise suppression. Further, if the call is transferred to a conventional voice phone call, it is beneficial to have a noise suppression algorithm running.

Accordingly, there is a need for a method of setting voice processing parameters in a communication device communicating with a voice recognition server.

### DESCRIPTION OF THE DRAWINGS

FIG. 1 is a block diagram of a telecommunications system according to the present invention;

FIG. 2 is a block diagram of a telematics communication unit for a vehicle according to the present invention;

FIG. 3 is a block diagram of a wireless communication device according to the present invention;

FIG. 4 is a flow chart showing a method for setting voice processing parameters in a communication device according to the present invention;

FIG. 5 is a flow chart showing a method for setting voice processing parameters in a communication device according to an alternate embodiment of the present invention;

FIG. 6 is a flow chart showing a method for setting voice processing parameters in a communication device according to an alternate embodiment of the present invention; and

FIG. 7 is a flow chart showing a method for setting voice processing parameters in a communication device according to a further alternate embodiment of the present invention.

### DESCRIPTION OF THE PREFERRED EMBODIMENTS

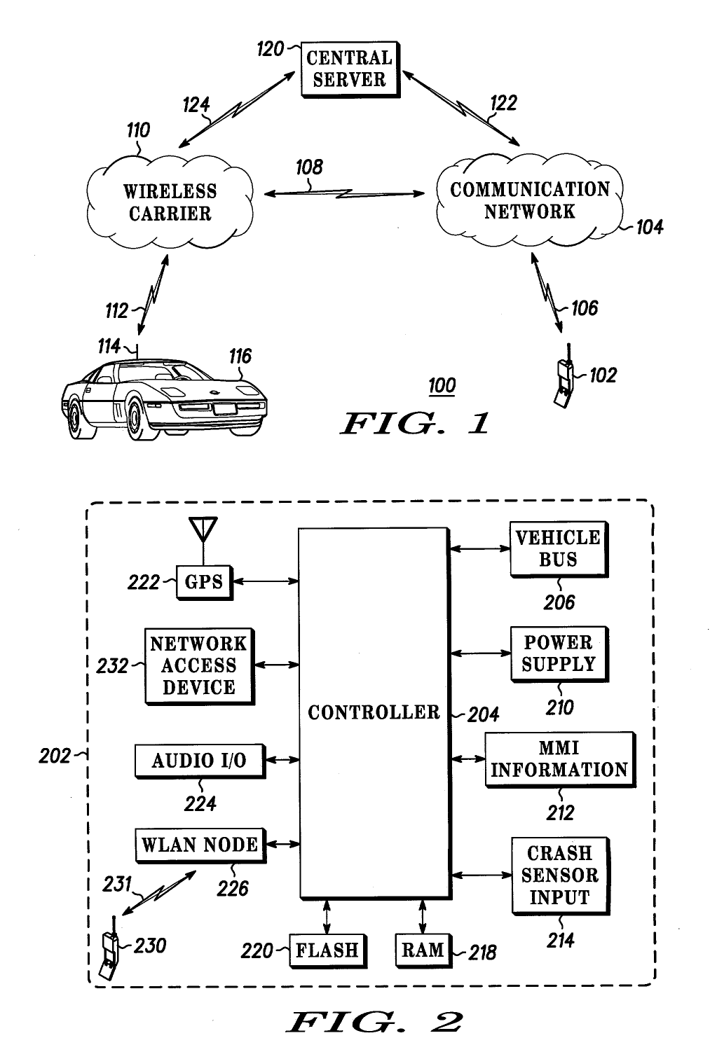

Turning first to FIG. 1, a system level diagram of a telecommunication system is shown. As will be described in detail in reference to later figures, a number of elements of a telecommunication system could employ the methods disclosed in the present application. In particular, a telecommunication system 100 preferably comprises a communication device 102 which is adapted to communicate with a communication network 104 by way of a communication link 106. The communication device 102 could be a wireless communication device, such as a cellular telephone, a pager, or a personal digital assistant (PDA) having wireless voice capability, or a conventional wire line device, such as a conventional telephone or a computer connected to a wire line network. Similarly, the communication network 104 could be any type of communication network, such as a land line communication network or a wireless communication network, both of which are well known in the art. A communication link 108 enables communication between the communication network 104 and a wireless carrier 110. The communication link 108 could be any type of communication link for processing voice signals, such as any type of signaling protocol used in any conventional landline or wireless communication network.

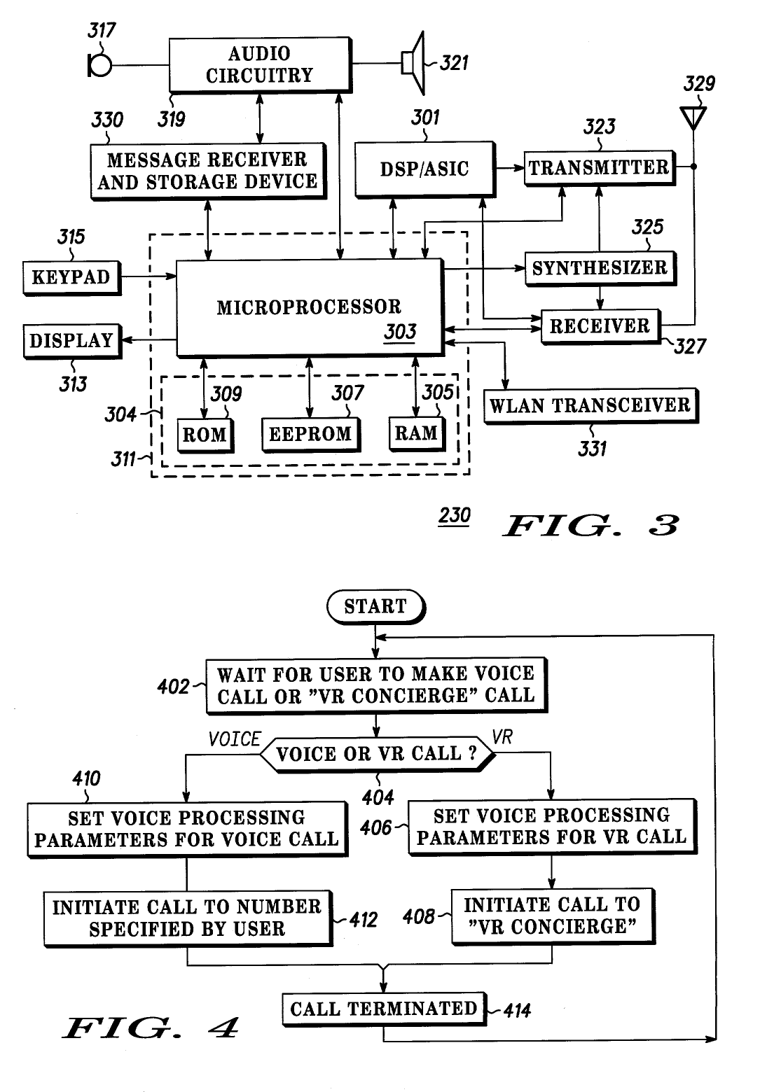

A second communication link 112 enables communication to a second wireless communication device 114 of a vehicle 116. The second wireless communication device 114 could be, for example, a telematics communication unit installed in a vehicle. Most current telematics systems include a wireless communication device embedded within the vehicle for accessing the telematics service provider. For example, conventional telematics units include a cellular telephone transceiver to enable communication between the vehicle and another communication device or a call center associated with telematics service for the vehicle. The vehicle could have a handset coupled to the wireless communication device, and/or include hands-free functionality within the vehicle. Alternatively, a portable phone operated by the user could be physically or wirelessly coupled to a wireless communication device of the telematics system, enabling synchronization between the portable phone and the wireless communication device of the vehicle. A telematics communication unit will be described in more detail in reference to FIG. 2.

The communication system 100 of FIG. 1 further includes a central server 120. The central server 120 could be, for example, a telematics service provider having a call processing server operated by employees, and/or a voice recognition system for receiving calls, as is well known in the art. Although the central server 120 is shown as a single element, the functions of a central server of a telematics service provider or other entity having voice recognition capability could be distributed. The central server 120 preferably communicates with the communication network 104 by way of a communication link 122, and with the wireless carrier 110 by way of a communication link 124.

Turning now to FIG. 2, a block diagram of a telematics communication unit 202 which could be installed in the vehicle 116 according to the present invention is shown. The telematics communication unit 202 preferably comprises a controller 204 having various input/output (I/O) ports for communicating with various components of a vehicle. For example, the controller 204 is coupled to a vehicle bus 206, a power supply 210, a man machine interface (MMI) 212, and a crash sensor input 214. The connection to the vehicle bus enables operations such as unlocking the door, sounding the horn, flashing the lights, etc. The controller 204 is also preferably coupled to various memory elements, such as a random access memory (RAM) 218 or a flash memory 220. The telematics controller 204 also preferably includes a global positioning system (GPS) unit 222 which provides the location of the vehicle, as is well known in the art. The telematics controller 204 is also preferably coupled to an audio I/O 224 which preferably includes a hands-free system for audio communication for a user of the vehicle by way of the network access device 232 or the wireless communication device 230 (by way of WLAN node 226). That is, the controller 204 couples audio communication from the network access device 232 to the audio I/O 224. Similarly, the controller 204 couples audio from the wireless communication device 230 (by way of communication link 231 and WLAN node 226) to the audio I/O 224. Alternatively, a wired handset could be coupled to the network access device 232.

Finally, the telematics unit 202 could include a wireless local area network (WLAN) node 226 which is also coupled to the telematics controller 204 and enables communication between a WLAN enabled device such as a wireless communication device 230 and the telematics controller 204 by way of the WLAN mode 226. According to one embodiment of the telematics communication unit 202, the wireless communication device 230 could provide the wireless communication functionality of the telematics communications unit 202, thereby eliminating the need for the network access device 232. Using a portable cellular telephone to provide the functionality of the wireless communication device for the telematics unit eliminates the need for a separate cellular transceiver, such as the network access device 232, in the vehicle, thereby reducing cost of the telematics unit. A WLAN enabled device could communicate with the WLAN enabled telematics controller 204 by any WLAN protocol, such as Bluetooth, EEE 802.11, IrDA, or any other WLAN application. Although WLAN node 226 is described as a wireless local area network, such a communication interface could by any short range wireless link, such as a wireless audio link.

Turning now to FIG. 3, a block diagram of the wireless communication device 230 such as a cellular radiotelephone incorporating the present invention is shown. In the preferred embodiment, an DSP/ASIC 301, and a microprocessor 303 combine to generate the necessary communication protocol for operating in a cellular system. Microprocessor 303 uses memory 304 comprising RAM 305, EEPROM 307, and ROM 309, preferably consolidated in one package 311, to execute the steps necessary to generate the protocol and to perform other functions for the communication unit, such as writing to a display 313, accepting information from a keypad 315, controlling a frequency synthesizer 325, or performing steps necessary to amplify a signal according to the method of the present invention. ASIC 301 processes audio transformed by audio circuitry 319 from a microphone 317 and to a speaker 321. A transceiver processes the radio frequency signals. In particular, a transmitter 323 transmits through an antenna 329 using carrier frequencies produced by a frequency synthesizer 325. Information received by the communication device's antenna 329 enters receiver 327 which demodulates the symbols comprising the message frame using the carrier frequencies from frequency synthesizer 325. The communication device may optionally include a message receiver and storage device 330 including digital signal processing means. The message receiver and storage device could be, for example, a digital answering machine or a paging receiver.

Turning now to FIG. 4, a flow chart shows a method for setting voice processing parameters in a communication device. The communication device could be, for example, the network access device 232 of a telematics communications unit 202, or the wireless communication device 230, or any telecommunications device which is calling a server or call center, such as 201 which has voice recognition capability. A communication device waits for a user to make a voice call or a call to a device having voice recognition capabilities, such as a voice recognition server of a telematics service provider providing a concierge service, at a step 402. The communication device then determines whether a call to a voice recognition server, such as the central server 120, is made at a step 404.

The communication device could determine whether a call is made to a voice recognition server in a number of ways. For example, a separate button could be provided on the wireless communication device 230 or on a user interface for the network access device 232 of a telematics communications unit. Whenever the button is selected, a call will be made to a voice recognition server of a telematics communication system, such as to the central server 120 of FIG. 1. Alternatively, a telephone number could be stored in a memory location designated to make a voice recognition server call. For example, the number for a voice recognition server could be stored with a voice recognition designator, such as an icon designating the number to be a voice recognition server. Alternatively, a flag could be set with every memory location indicating the type of device at the destination number, for example whether a call should be initiated as a voice call or a VR call. Alternatively, a communication device calling a voice recognition server could recognize a particular number which is typically associated with a voice recognition call. For example, a certain area code or local exchange number, or both, could be used to designate voice recognition servers. Finally, for a number entered on the keypad, the communication device could compare the number to numbers on a list of voice servers, or to a number stored in a memory location having a voice recognition designation or flag indicating the type of device at the destination number.

If a call to a voice recognition server is made, the communication device sets voice processing parameters for a voice recognition call at a step 406. For example, noise suppression could be turned off or set to a desired level, such as a level which is a function of the noise level. The device then initiates a call to the voice recognition server at a step 408. However, if the communication device makes a voice call to a device other than a voice recognition server, such as to a human operator, at the step 404, the communication device sets voice processing parameters for a voice call at a step 410, and initiates a call to a number specified by a user at a step 412. If no designation, such as a voice recognition designator or flag, that would indicate the type of device at the destination number is provided, the communication device would use a default mode, such as a voice call mode. In any case, the call is terminated at a step 414 and the communication device returns to a stand-by mode to wait for the user to make another call at the step 402.

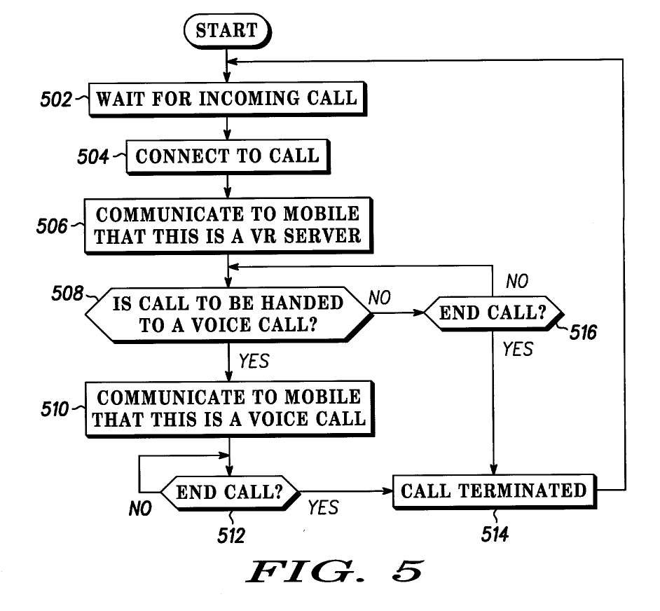

Turning now to FIG. 5, a method for setting voice processing parameters of a communication device according to an alternate embodiment of the invention is shown. A communication device, such as the central server 120, the network access device 232, the wireless communication device 230, or any other telecommunication device, waits for an incoming call at a step 502. The communication device connects to the call at a step 504. A message is communicated from a voice recognition server to another communication device indicating that the voice recognition server has voice recognition capability at a step 506. For example, the voice recognition server could be the central server 120 operated by a telematics service provider and having voice synthesis and voice recognition capability. The server preferably provides messages or commands via a known protocol that the other communication device can decipher. If the other communication device is properly equipped to change its voice parameters, it will change its voice parameters to optimize for a voice recognition server.

It is then determined whether the call is to be transferred to a voice call at a step 508. If the call is to be transferred, the server communicates to the other communication device that the call has been transferred to a voice call at a step 510. If the other communication device is equipped, it will then change its voice parameters to optimize for a voice call. The other communication device then determines whether the call has ended at a step 512. Alternatively, if the other communication device is not handed to a voice call at the step 508, it will determine whether the call has ended at a step 516. If the call has not ended, the other communication device will continue to determine whether the call is transferred to a voice call at the step 508. If the call is ended, the call is terminated at a step 514, and the communication devices continue to wait for another incoming call at a step 502.

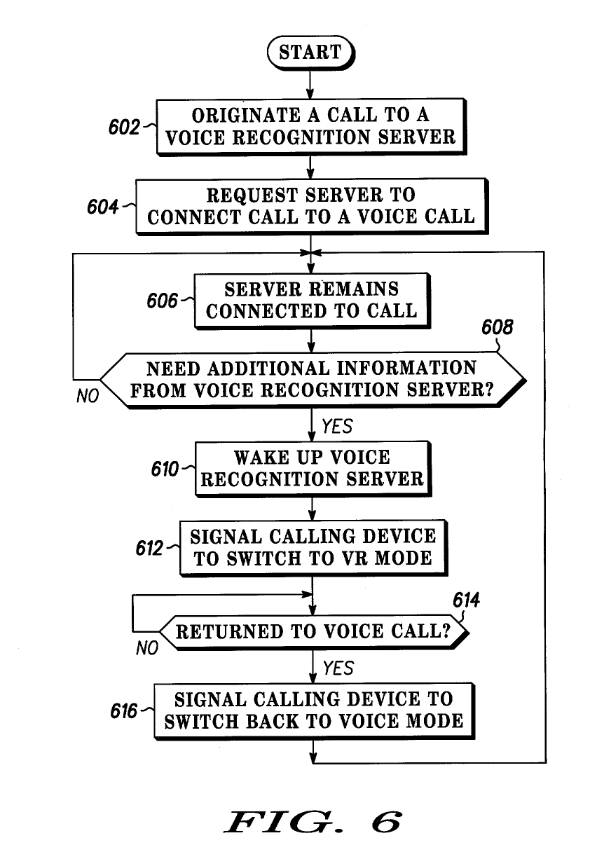

Turning now to FIG. 6, a method for setting voice processing parameters according to an alternate embodiment of the present invention is shown. In particular, a communication device originates a call to a voice recognition server at a step 602. The call could be, for example, a call from the wireless communication device 114 to the central server 120 of FIG. 1. The user of the communication device then requests the voice recognition server to connect the call to a voice call at a step 604. For example, a telematics communications subscriber could request a telematics service provider to connect the user to a predetermined number which is preferably known by the telematics service provider. Preferably the server remains connected to the call at a step 606.

It is then determined whether additional information is needed from the voice recognition server at a step 608. If additional information is needed, the user wakes up the voice recognition server at a step 610. The user could wake up the voice recognition server by, for example, selecting a predetermined button or key sequence on the communication device, or by stating a predetermined word or phrase that would be recognized by the voice recognition server. The voice recognition server would then signal the calling device to switch to the voice recognition mode at a step 612. Alternatively, the calling device could automatically switch itself to the voice recognition mode in response to the selection of a button or the use of the predetermined word or phrase. It is then determined whether the call should be returned to a voice call at a step 614. For example, if the server is done providing voice recognition services to the user of the communication device, the server preferably sends a signal to the communication device to switch back to voice call mode at a step 616.

While the method of FIG. 6 enables the automatic switching between the voice recognition mode and the voice call mode by the network, it is also contemplated that a communication device could include keys which would enable the user to switch back and forth between voice recognition mode and voice call mode as desired by the user of the device. For example, dedicated keys or soft keys on the communication device could be used to manually switch between modes. Similarly, the communication device could respond to a specific verbal command to switch voice processing parameters to voice recognition processing parameters or standard voice call parameters as desired. Accordingly, the call would be made using desired call processing parameters requested by the user regardless of the destination number.

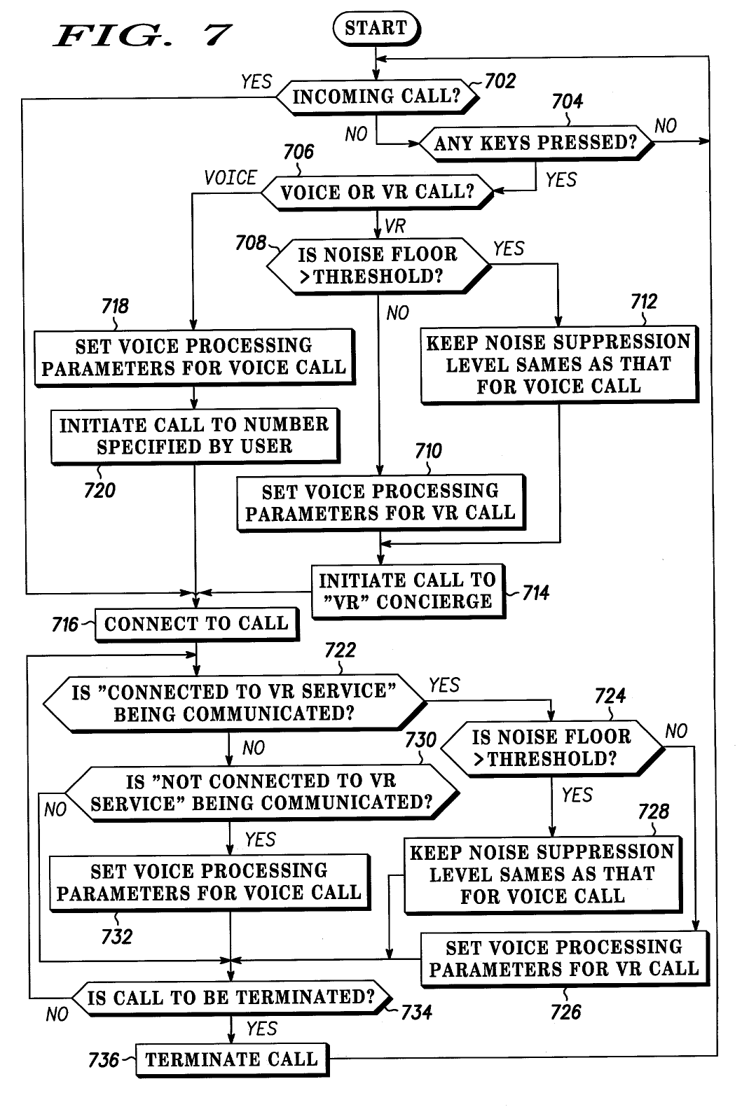

Turning now to FIG. 7, a flow chart shows a method for setting voice processing parameters according to a further alternate embodiment of the invention. A communication device, such as the network access device 232, the wireless communication device 230, or any other telecommunication device capable of receiving a voice call, determines whether an incoming call is received at a step 702. If no incoming call is received, the communication device determines whether any key is pressed at a step 704. If a key is pressed, the communication device determines whether a conventional voice call or a call to a voice recognition server, such as central server 120, is made at a step 706. If it is determined that a call to a voice recognition server is made, the communication device then determines whether a noise floor (i.e., background noise) is greater than a predetermined threshold at a step 708. Generally, a voice recognition server will work better if the communication device providing communication signals does not have any noise suppression algorithm running due to the voice distortion caused by the non-linear processing of most noise suppression algorithms. However, one exception is when the noise floor is very high. In this case, the noise suppression will enhance the voice recognition. Accordingly, if the noise floor is not greater than the threshold, the communication device sets the voice processing parameters for a voice recognition call at a step 710. Alternatively, if the noise floor is greater than the predetermined threshold, the communication device maintains the noise suppression level at the same level for a voice call or some other appropriate level at a step 712. After setting the voice processing parameters, the communication device initiates a call at a step 714.

After connecting to a call at a step 716, the communication device determines whether a message is communicated to the communication device that it is connected to a voice recognition server at a step 722. If the communication device is receiving the message that it is connected to a voice recognition server, the communication device then determines whether the noise floor is greater than a predetermined threshold at a step 724. If not, the communication device sets the voice processing parameters for a voice recognition call at a step 726. If the noise floor is greater than a predetermined threshold at a step 724, the communication device maintains the voice processing parameters for a voice call or applies some other appropriate parameters at a step 728.

If no message indicating that the communication device is connected to a voice recognition server is received at step 722, the communication device determines whether it receives a message that it is not connected to a voice recognition server at a step 730. If such a message is received, the communication device sets the voice processing parameters for a voice call at a step 732. Finally, the communication device determines whether a call is terminated at a step 734. If not, the communication device determines whether a message is received at step 722 or step 730 indicating a change in the type of communication with the server. Finally, the call is terminated at a step 736, and enters a standby mode to determine whether an incoming call is received again at the step 702 or a call is initiated at the step 704.

It can therefore be appreciated that a new and novel method for setting voice parameters in a communication device has been described. Although the methods of the present disclosure find particular application in the field of telematics, and more particularly the area of hands-free voice communication from a vehicle to a server having voice recognition capabilities, the methods of the present disclosure could be employed with any communication device making a voice call to any other device having voice recognition capabilities. It will be appreciated by those skilled in the art that, given the teaching herein, numerous alternatives and equivalent will be seen to exist which incorporate the disclosed invention. As a result, the invention is not to be limited by the foregoing exemplary embodiments, but only by the following claims.

We claim:

1. A method of setting voice processing parameters in a communication device, said method comprising the steps of:
detecting the selection of a number to be dialed, said number to be dialed being designated by a user to enable a voice recognition call;
setting voice processing parameters of said communication device for said voice recognition call; and
enabling voice communication with a voice recognition server using said voice processing parameters.

2. The method of claim 1 wherein said step of detecting the selection of a number to be dialed comprises detecting the selection of a predetermined button.

3. The method of claim 1 wherein said step of detecting the selection of a number to be dialed comprises detecting the selection of a predetermined destination number stored by a user.

4. The method of claim 3 wherein said step of detecting the selection of a number to be dialed comprises detecting the selection of a destination number stored in predetermined location.

5. The method of claim 3 wherein said step of detecting the selection of a number to be dialed comprises detecting a voice recognition designator stored with a destination number.

6. The method of claim 1 wherein said step of setting voice processing parameters comprises setting a noise suppression level.

7. The method of claim 1 further comprising a step of determining if said voice communication is to be transferred from said voice recognition server to a voice call.

8. The method of claim 1 further comprising a step of determining whether a noise level is greater than a predetermined threshold.

9. The method of claim 8 further comprising a step of setting a noise suppression level at a predetermined level if said noise level is greater than a predetermined threshold.

10. A method of setting voice processing parameters in a communication device, said method comprising the steps of:
detecting the selection of a number to be dialed, said number to be dialed being designated by a user to enable a voice recognition call on a telematics communication device of a vehicle;
setting noise suppression parameters of said telematics communication device for said voice recognition call; and
enabling hands-free voice communication with a voice recognition server using said noise suppression parameters.

11. A method of setting voice processing parameters in a communication device, said method comprising the steps of:
detecting the selection of a button on a wireless communication device to initiate a voice recognition call;
setting a noise suppression level of said communication device for said voice recognition call; and
enabling voice communication with a voice recognition server using said noise suppression level.

12. The method of claim 11 further comprising a step of determining if said voice communication is to be transferred from said voice recognition server to a voice call.

13. The method of claim 11 further comprising a step of determining whether a noise level is greater than a predetermined threshold.

14. The method of claim 13 further comprising a step of setting said noise suppression level at a predetermined level if said noise level is greater than said predetermined threshold.

15. A method of setting voice processing parameters in a communication device, said method comprising the steps of:
detecting the selection of a button on a telematics communication device associated with a vehicle to initiate a voice recognition call;
setting a noise suppression level of said telematics communication device for said voice recognition call; and
enabling hands-free voice communication with a voice recognition server using said noise suppression level.

16. A method of setting voice processing parameters in a communication device, said method comprising the steps of:
detecting the selection of a predetermined destination number stored by a user to initiate a voice recognition call;
setting a noise suppression level of said communication device for said voice recognition call; and
enabling voice communication with a voice recognition server using said noise suppression level.

17. The method of claim 16 wherein said step of detecting the selection of a predetermined destination number comprises detecting a destination number stored in predetermined location.

18. The method of claim 16 wherein said step of detecting the selection of a predetermined destination number comprises detecting a voice recognition designator stored with a destination number.

19. The method of claim 16 further comprising a step of determining if said voice communication is to be transferred from said voice recognition server to a voice call.

20. The method of claim 16 further comprising a step of determining whether a noise level is greater than a predetermined threshold.

21. The method of claim 20 further comprising a step of setting said noise suppression level at a predetermined level if said noise level is greater than said predetermined threshold.

22. A method of setting voice processing parameters in a communication device, said method comprising the steps of:
detecting a predetermined destination number stored by a user on a telematics communication device associated with a vehicle to initiate a voice recognition call;
setting a noise suppression level of said telematics communication device for a voice recognition call; and
enabling hands-free voice communication with a voice recognition server using said noise suppression level.

23. A method of setting voice processing parameters in a communications device, said method comprising the steps of:
receiving an incoming call from said communication device at a call processing server;
providing an indication to said communication device that said call processing server has voice recognition capability; and
enabling a call with said communication device.

24. The method of claim 23 wherein said step of receiving an incoming call comprises receiving a call at a telephone number dedicated to a voice recognition server.

25. The method of claim 23 wherein said step of providing an indication comprises instructing said communication device to set voice processing parameters for a voice recognition call.

26. The method of claim 23 further comprising a step of instructing said communication device to set voice processing parameters for a voice recognition call.

27. The method of claim 23 further comprising a step of determining whether said call is to be transferred to a voice call.

28. The method of claim 27 further comprising a step of providing an indication to said communication device that said call is to be transferred.

29. The method of claim 28 wherein said step of providing an indication comprises providing instructions to said communication device to change said voice processing parameters.

30. The method of claim 28 further comprising a step of instructing said communication device to change said voice processing parameters.

31. A method of setting voice processing parameters in a communication device, said method comprising the steps of:
initiating a call to a voice recognition server from a telematics communication device.
receiving an incoming call from said telematics communication device at said voice recognition server;
providing an indication that said voice recognition server has voice recognition capability to said telematics communication device;
instructing said telematics communication device to set a noise suppression level to a predetermined level for a voice recognition call;
setting said noise suppression level of said communication device for a voice recognition call; and
enabling a call between said telematics communication device and said voice recognition server.

32. The method of claim 31 wherein said step of initiating a call to a voice recognition server from a telematics communication device comprises detecting the selection of a predetermined button associated with said telematics communications unit.

33. The method of claim 31 wherein said step of initiating a call to a voice recognition server from a telematics communication device comprises detecting the selection of a predetermined destination number.

34. The method of claim 33 wherein said step of detecting the selection of a predetermined destination number comprises detecting the selection of a destination number stored in predetermined location.

35. The method of claim 33 wherein said step of detecting the selection of a predetermined destination number comprises detecting a voice recognition designator stored with a destination number.

36. The method of claim 31 wherein said step of enabling a call between said telematics communication device and said voice recognition server comprises enabling hands-free voice communication from said telematics communication device.

37. The method of claim 31 further comprising a step of determining if said call is to be transferred from said voice recognition server to a voice call.

38. The method of claim 31 further comprising a step of determining whether a noise level is greater than a predetermined threshold.

39. The method of claim 38 further comprising a step of maintaining a noise suppression level at a predetermined level if said noise level is greater than said predetermined threshold.
